(19) United States
(12) Patent Application Publication
(10) Pub. No.: US 2018/0294447 A1
(43) Pub. Date: Oct. 11, 2018

(54) CAP ASSEMBLY FOR A SECONDARY BATTERY AND SECONDARY BATTERY

(71) Applicant: Contemporary Amperex Technology Co., Limited, Ningde City (CN)

(72) Inventors: Zhijun GUO, Ningde City (CN); Mingchuan SUN, Ningde City (CN); Peng WANG, Ningde City (CN); Taosheng ZHU, Ningde City (CN)

(73) Assignee: Contemporary Amperex Technology Co., Limited, Ningde City (CN)

(21) Appl. No.: 15/823,131

(22) Filed: Nov. 27, 2017

(30) Foreign Application Priority Data
Apr. 7, 2017 (CN) 201710226824.4

(51) Int. Cl. H01M 2/04; H01M 2/12; H01M 2/34; H01M 10/04

(52) U.S. Cl. CPC H01M 2/046; H01M 2/1229; H01M 2/345; H01M 2200/20; H01M 10/04; H01M 2/0413; H01M 2/1241

(57) ABSTRACT

The present disclosure provides a cap assembly for a secondary battery and the secondary battery. The cap assembly of the secondary battery includes: a cap plate including a cover sheet having a first electrode lead-out hole; a first terminal member including a first terminal and a conductive sealing ring, the first terminal penetrating into the first electrode lead-out hole and the conductive sealing ring surrounding the first terminal and sealing the first electrode lead-out hole, wherein the conductive sealing ring is in a compression state, the first terminal is electrically connected with the cover sheet through the conductive sealing ring, and the conductive sealing ring has a resistance value greater than a resistance value of the first terminal.

### CROSS-REFERENCE TO RELATED APPLICATIONS

The present application is based upon and claims priority to Chinese Patent Application No. 201710226824.4 filed on Apr. 7, 2017, the entire contents of which are incorporated herein by reference.

### TECHNICAL FIELD

The present disclosure relates to the technical field of energy storage elements, and in particular, to a cap assembly for a secondary battery and a secondary battery.

### BACKGROUND

Currently, in the field of power battery, a hard shell is usually used to accommodate electrode assembly and is generally made of a metal material in order to ensure safety during use of the battery. A nail penetration test is generally required to ensure safety during use of a secondary battery. If a first terminal and the shell of the battery are connected directly using a metal material, a loop current when the battery is subjected to the nail penetration test sharply increases because resistance value of a metal material is generally in an order of milliohms and thus ignition might occur at penetration, which may cause fire or other security risks. Further, in the case that an aluminum shell is used, the aluminum shell is vulnerable to be corroded by electrolyte due to a low standard electrode potential of the aluminum. In order to solving the problem that the shell is vulnerable to be corroded, the aluminum shell must be connected with a positive terminal of the battery such that the aluminum shell is positively charged. However, if a metal material is used for the connection, a loop current when the battery is short-circuited increases because resistance value of a metal material is generally in an order of milliohms and thus ignition might occur, which may cause fire or other security risks.

A specific method conventionally used is that upper plastic on a cap structure of the battery is made of a conductive plastic so as to realize an ohmic connection between the first terminal and a cover sheet. However, the upper plastic has poor compression performance due to its material characteristics. Moreover, the first terminal and the cover sheet does not produce a uniform pressure on the entire upper plastic, that is, during use of the battery, the upper plastic is not subject to a uniform compressive stress. Therefore, a contact area of a mating surface between the plastic and the cover sheet or the first terminal is unstable (for example, due to thermal expansion and contraction, the plastic has an inconsistent contraction rate with the first terminal and thus a seam is formed between mating surfaces of the plastic and the cover sheet or between the plastic and the first terminal), resulting in a problem that a resistance value between the first terminal and the cover sheet is not stable. Another method in related art is to provide a resistance having thermostability (such as silicon carbide) between the first terminal and the cover sheet. Hoverer, such resistance having thermostability has poor compressibility and large brittleness due to its material characteristics, and thus if it is mounted too tightly, it is easily crushed under the effect of thermal expansion and contraction, while if it is not pressed tightly when assembled, it is difficult to ensure a stable contact area with the first terminal and the cover sheet, and thereby there still exists the problem that the resistance value is unstable.

### SUMMARY

According to an aspect of the present disclosure, there is provided a cap assembly for a secondary battery. The cap assembly includes: a cap plate including a cover sheet having a first electrode lead-out hole; a first terminal member including a first terminal and a conductive sealing ring, the first terminal penetrating into the first electrode lead-out hole and the conductive sealing ring surrounding the first terminal and sealing the first electrode lead-out hole, wherein the conductive sealing ring is in a compression state, the first terminal is electrically connected with the cover sheet through the conductive sealing ring, and the conductive sealing ring has a resistance value greater than a resistance value of the first terminal.

According to an embodiment of the present disclosure, the cap assembly for a secondary battery further includes a fixing member located on one side of the cap plate and engaged with the first terminal in order to fix the first terminal to the cap plate, wherein the conductive sealing ring is disposed in a space surrounded by the first terminal, the cap plate and the fixing member.

According to an embodiment of the present disclosure, the conductive sealing ring is in surface contact with the cap plate, the first terminal and the fixing member respectively.

According to an embodiment of the present disclosure, the space is enclosed and the conductive sealing ring fills the space.

According to an embodiment of the present disclosure, the conductive sealing ring is made of an elastic material.

According to an embodiment of the present disclosure, the resistance value of the conductive sealing ring ranges from 1 ohm to 10⁵ ohm.

According to an embodiment of the present disclosure, the conductive sealing ring has a compression rate from 15% to 50%.

According to an embodiment of the present disclosure, the elastic material is one of conductive fluororubber, conductive ethylene-propylene-diene monomer or conductive nitrile rubber.

According to an embodiment of the present disclosure, the first terminal is a positive terminal.

According to another aspect of the present disclosure, there is provided a secondary battery. The secondary battery includes: a shell having an opening; an electrode assembly provided within the shell and including a first electrode and a second electrode, wherein the second electrode has an opposite polarity to the first electrode; and a cap assembly of the secondary battery as discussed above, wherein the cap assembly covers the opening of the shell, and the first electrode of the electrode assembly is connected electrically to the first terminal.

### BRIEF DESCRIPTION OF THE DRAWINGS

The invention may be better understood from the following descriptions of specific embodiments of the invention by taken in conjunction with the accompanying drawings, in which:

FIG. 1 is a perspective view of a structure of a cap assembly 101 for a secondary battery according to embodiments of the present disclosure;

FIG. 2 is a schematic top view of the structure of the cap assembly 101 for a secondary battery of FIG. 1;

FIG. 3 is a schematic cross-sectional diagram of the structure of the cap assembly 101 in FIG. 2 taken along the A-A direction;

FIG. 4 is an enlarged partial view of a portion A of the cap assembly 101 of FIG. 3;

FIG. 5 is a schematic top view of a structure of a cap assembly 102 for a secondary battery according to embodiments of the present disclosure;

FIG. 6 is a schematic cross-sectional diagram of the structure of the cap assembly 102 of FIG. 5 taken along the B-B direction;

FIG. 7 is an enlarged partial view of a portion B of the cap assembly 102 of FIG. 6;

FIG. 8 is a schematic top view of a structure of a cap assembly 103 for a secondary battery according to embodiments of the present disclosure;

FIG. 9 is a cross-sectional diagram of the structure of the cap assembly 103 of FIG. 8 taken along the C-C direction; and

FIG. 10 is an enlarged partial view of a portion C of the cap assembly 103 of FIG. 9.

101 Cap assembly of the secondary battery
102 Cap assembly of the secondary battery
103 Cap assembly of the secondary battery
10 Cap plate
11 Cover sheet
12 First insulating plate
13 Second insulating plate
14 Injection hole
15 Anti-explosion valve component
20 First terminal member
21 First terminal
211 Electrical connection plate
22 Fixing element
23 Conductive sealing ring
30 Second terminal member
31 Second terminal
311 Electrical connection plate
32 Fixing element
33 Insulating sealing ring

### DETAILED DESCRIPTION

The features and exemplary embodiments of the various aspects of the present invention will be described in detail below. In the following detailed descriptions, numerous specific details are set forth in order to provide a thorough understanding of the present invention. It will be apparent, however, to those skilled in the art that the present invention may be practiced without the need for some of the details in these specific details. In the drawings and the following descriptions, at least a part of well-known structures and techniques is not shown in order to avoid unnecessarily obscuring the present invention. Further, for clarity, the size of some of the structures may be exaggerated. The same reference numerals in the drawings denote the same or similar structures, and thus their detailed descriptions will be omitted. Furthermore, the features, structures, or characteristics described below can be combined in any suitable manner in one or more embodiments.

The terms denoting directions that appear in the following description indicate directions shown in the drawings, and do not limit specific structure of the cap assembly for a secondary battery of the present disclosure. In the descriptions of the present disclosure, it should also be noted that the terms “mounted”, “connected” and “connection” should be interpreted in a broad sense unless explicitly defined and limited otherwise. For example, it may indicate “fixed connection”, “disassemble connection” or “integral connection”; it may indicate a mechanical connection or an electrical connection; it may indicate a direct connection or an indirect connection. For those skilled in the art, specific meanings of the above terms in the present disclosure may be understood as the case may be.

The cap assembly for a secondary battery provided by embodiments of the present disclosure is used for being connected at an opening of a shell of the secondary battery so as to seal an electrode assembly within the shell and meanwhile enable a cap structure is electrically connected with a first electrode and a second electrode having an opposite polarity to the first electrode of the internal electrode assembly so as to attain an electrical connection of the electrode assembly with outside. In the cap assembly for a secondary battery according to embodiments of the present disclosure, a conductive sealing ring is provided which has a resistance value greater than a resistance value of a first terminal electrically connected with the first electrode, which enables an electrical connection between the first terminal of the secondary battery and a cover sheet of a cap plate and enables a resistance value between the first terminal and the cover sheet to be always kept stable.

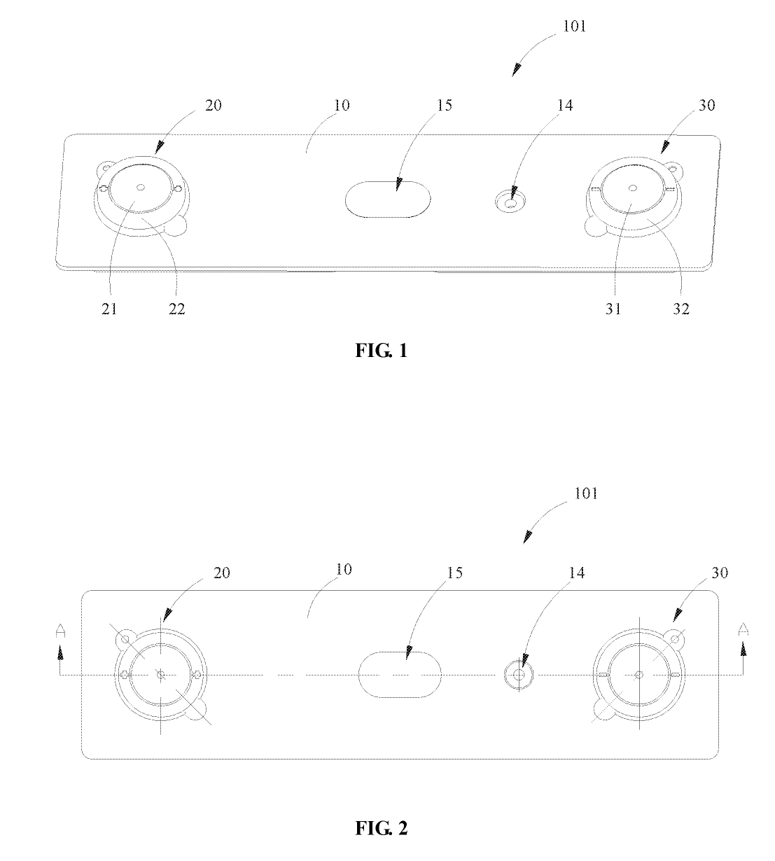

For a better understanding of the present disclosure, a cap assembly for a secondary battery according to embodiments of the present disclosure will be described in detail below with reference to FIG. 1 to FIG. 10.

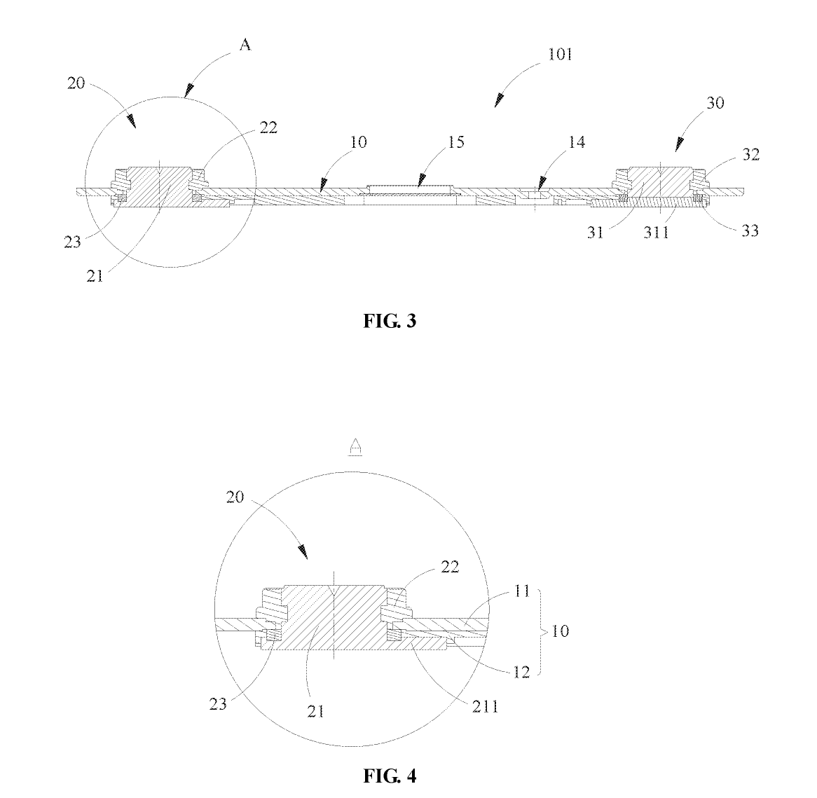

FIG. 1 is a perspective view of a structure of a cap assembly 101 for a secondary battery according to a first embodiment of the present disclosure; FIG. 2 is a schematic top view of the structure of the cap assembly 101 for a secondary battery of FIG. 1; and FIG. 3 is a schematic cross-sectional diagram of the structure of the cap assembly 101 for a secondary battery of FIG. 2 taken along the A-A direction.

As shown in FIG. 1, FIG. 2 and FIG. 3, there is provided a cap assembly 101 for a secondary battery according to an embodiment of the present disclosure. The cap assembly includes a cap plate 10 and a first terminal member 20 on the cap plate 10. The cap plate 10 includes a cover sheet 11 having a first electrode lead-out hole. The first terminal member 20 includes a first terminal 21 and a conductive sealing ring 23. The first terminal 21 penetrates into the first electrode lead-out hole. The conductive sealing ring 23 surrounds the first terminal 21 and seals the first electrode lead-out hole. The conductive sealing ring 23 is in a compression state. The first terminal 21 is electrically connected to the cover sheet 11 through the conductive sealing ring 23. The conductive sealing ring 23 has a resistance value greater than a resistance value of the first terminal 21. The compression state of the conductive sealing ring 23 means that the conductive sealing ring 23, upon the cap assembly 101 of the secondary battery is assembled, is always in compression in a tightly pressed direction. The pressing direction may be an axial direction of the first electrode lead-out hole, or a radial direction of the first electrode lead-out hole. Preferably, the pressing direction is the axial direction of the first electrode lead-out hole.

In this manner, the cap assembly 101 according to embodiments of the present disclosure realizes, by providing the conductive sealing ring 23 between the cover sheet 11 of the cap plate 10 and the first terminal 21, an electrical connection of the cover sheet 11 with the first terminal through the conductive sealing ring 23. Since the conductive sealing ring 23 is always in a tightly pressed state, that is, the conductive sealing ring 23 is always subjected to a uniform compressive stress provided by the cap plate 10 and the first terminal 21, it can be ensured that the conductive sealing ring 23 provides a constant resistance value. Therefore, the cap assembly 101 of embodiments of the present disclosure attains an electrical connection of the cover sheet 11 and the first terminal 21 through the conductive sealing ring 23 without any additional redundant components, and enables the conductive sealing ring 23 to be always in a tightly pressed state so as to avoid changes in the resistance value of the conductive sealing ring 23 due to influence during use of the secondary battery.

In an embodiment, the secondary battery has a shell (not shown in the drawings), an electrode assembly (not shown in the drawings) housed in the shell, and the cap assembly 101. The shell may be a hollow box, and may be made of a metal material such as aluminum or aluminum alloy. At one end of the shell, there is provided an opening, through which the electrode assembly are placed in the shell. The cap assembly 101 is connected at the opening of the shell to enclose the electrode assembly within the shell.

According to exemplary embodiments of the present disclosure, the cap plate 10 of the cap assembly 101 includes a cover sheet 11 and a first insulating plate 12. Both of the cover sheet 11 and the first insulating board 12 are in a thin plate shape. The cover sheet 11 is made of metal, for example, may be made of the same material as the shell (i.e., aluminum or aluminum alloy), and has a size and shape matching the opening of the shell so as to be capable of being connected at the opening of the shell. The first insulating plate 12 is made of a non-metallic material, for example, plastic, and may be integrally molded. The first insulating plate 12 is attached to a side of the cover sheet 11 close to the shell (i.e., the interior of the shell and, of course, outer side and inner side are defined with respect to a accommodation space formed upon the cover sheet 11 of the cap plate 10 covering on the shell, which is also applied to the following descriptions). The cover sheet 11 has a first electrode lead-out hole (not shown), a second electrode lead-out hole (not shown), an injection hole 14 and an anti-explosion valve 15.

The injection hole 14 is provided on the cover sheet 11 with a predetermined size so that it is able to inject, upon the cap plate 10 covers the opening of the shell and seals and is connected with the shell, electrolyte into the accommodation space within the shell through the injection hole 14.

The anti-explosion valve 15 may be implemented by a conventional structure (for example, a rupture disc). The anti-explosion valve 15 may be provided substantially at middle of the cover sheet 11. When gas is generated due to over-charging, over-discharging or over-heating of the battery to cause internal pressure of the secondary battery is excessively large, the rupture disc of the anti-explosion valve is destroyed so that the gas inside the secondary battery can be discharged to outside through a through-hole of the anti-explosion valve 15, whereby explosion of the secondary battery can be prevented.

The first electrode lead-out hole and the second electrode lead-out hole are respectively used for penetration of the first terminal 21 and the second terminal 31. Since the first terminal member 20 and the second terminal member 30 have the same structure and are installed in the cap plate 10 in the same manner, so the cap assembly 101 will be described in detail by taking the structure of the first terminal member 20 and its installation in the cap plate 10 as an example only.

FIG. 4 is an enlarged partial view of a portion A of the cap assembly 101 of FIG. 3. Referring to FIGS. 1-4, the first terminal assembly 20 includes a first terminal 21, a fixing member 22 and a conductive sealing ring 23 having a predetermined resistance value, according to exemplary embodiments of the present disclosure. Illustratively, the first terminal member 20 is a positive terminal member. The first terminal 21 generally includes three portions: an external connection portion for attaining an electrical connection with external components, a connection portion for attaining a fixed connection with the cap plate 10, and an internal connection portion for attaining an electrical connection inside the battery (secondary battery) with positive electrode tabs of the electrode assembly within the shell. In the embodiment, specifically, the first terminal 21 is a positive terminal, and includes a terminal body and an electrical connection plate 211 connected to the terminal body. The terminal body may be a cylindrical structure and may be made of aluminum or aluminum alloy. The terminal body may be integrally formed with the electrical connection plate 211. The area of the electrical connection plate 211 is larger than the area of cross-section of the terminal body. The top surface (in the perspective of FIG. 4) of the terminal body of the first terminal 21 is the external connection portion for attaining an electrical connection with positive electrode tabs through the electrical connection plate 211, while the first terminal 21 located between the top surface and the electrical connection plate 211 is used for being fixed on the cap plate 10 by the fixing member 22.

Exemplarily, the fixing member 22 may be a ring structure. In the embodiment, the fixing member 22 may be made of a non-metal material, and preferably made of a high temperature-resistant insulating plastic material by integral injection molding. For example, it may be made of one or more of polyphenylene sulfide Ether (PPS), perfluoroalkoxy resin (PEA) or polypropylene (PP). In order to fix the first terminal 21 on the cap plate 10, an annular recess is provided on one of the terminal body and the fixing member 22 at contact surfaces of the terminal body and the fixing member 22 facing each other, and a annular convex capable of engaging with the annular recess is correspondingly provided on the other one, thereby forming an engaging structure for insulate connection of the first terminal 21 and the cover sheet 11.

In this way, the terminal body of the first terminal 21 penetrates into the first electrode lead-out hole outwardly (i.e., outward from the shell), the fixing member 22 is provided on a side of the cover sheet 11 away from the shell (i.e., outer sidewall of the cap plate 10), the first terminal 21 is engaged (may also be referred to as “riveted”) with the fixing member 22 through a corresponding engagement structure provided between the terminal body and the fixing member 22, and the electrical connection plate 211 abuts a side of the first insulating plate 12 close to the shell (i.e., inner sidewall of the cap plate 10), so that the first terminal 21 is fixed to the cap plate 10. Therefore, an inner wall of the through hole of the cover sheet 11 and the terminal body of the first terminal 21 are electrically insulated from each other by the fixing member 22, and the cover sheet 11 and the electrical connection board 211 are electrically insulated from each other by the first insulating plate 12.

The embodiments of the present disclosure are not limited to the specific form of the fixing member 22. In other embodiments, the fixing member 22 may be other insulating structures. Also, the first terminal 21 may be fixed on the cap plate 10 by a locking structure or in any other engagement manner. In addition, the embodiments of the present disclosure are not limited to the specific shapes of the terminal body of the first terminal 21 and the electrical connection plate 211 connected with the terminal body. In other embodiments, the terminal body and the electrical connection plate 211 may be separate structures.

In an embodiment, the conductive sealing ring 23 surrounds the first terminal 21 and is disposed in a space surrounded by the cap plate 10, the first terminal 21 and the fixing member 22 so as to be electrically connected to the first terminal 21 and the cover sheet 11 of the cap plate 10 and to enable seal between the first terminal 21 and the first electrode lead-out hole such that the shell connected with the cover sheet 11 is positively charged to prevent the shell from being corroded by electrolyte. In addition, the conductive sealing ring 23 may be made of a material having sealing performance. For example, it may be made of a master batch of a material having sealing performance with a conductive material added therein. The conductive sealing ring 23 has a predetermined resistance value. Actually, the resistance value of the conductive sealing ring 23 only needs to be greater than the resistance value of the first terminal 21. Specifically, the resistance value of the conductive sealing ring 23 can be selected according to specific type of the battery and materials of the first terminal 21 and the cover sheet 11. For example, the resistance value of the conductive sealing ring 23 may range from 1 ohm to 10⁵ ohm.

According to embodiments of the present disclosure, the conductive sealing ring 23 is in close contact with the cap plate 10, the first terminal 21 and the fixing member 22 so that the conductive sealing ring 23 fully fills the space surrounded by the cap plate 10, the first terminal 21 and the fixing member 22. Depending on structures of the cap plate 10 and the fixing member 22, the conductive sealing ring 23 for electrically connecting the first terminal 21 and the cover sheet 11 has various arrangements. In an embodiment, as shown in FIG. 4, the size of the through hole of the cover sheet 11 is larger than the size of the terminal body of the first terminal 21, and the fixing member 22 makes inner walls of the through hole of the cover sheet 11 to be electrically insulated from the first terminal body of the first terminal 21. Therefore, the space herein is surrounded by the cover sheet 11, the first insulating plate 12, the first terminal 21 and the fixing member 22. That is, the conductive sealing ring 23 is pressed against an inner surface of the cover sheet 11 (i.e., facing the inside of the shell), the through hole wall of the first insulating plate 12, the bottom surface of the fixing member 22, the terminal body of the first terminal 21 and an outer surface of the electronic connection plate 211 (i.e., far away from the inside of the shell) in a surface contact manner. In other words, the cover sheet 11 and the first terminal 21 compress the conductive sealing ring 23 in a direction along height of the conductive sealing ring 23 (may be referred to as thickness direction) so that the cover sheet 11 can be electrically connected to the first terminal 21 through the conductive sealing ring 23. In order to better fix the conductive sealing ring 23, a mounting groove may be provided on the electrical connection plate 211 of the first terminal 21 at a position corresponding to the mounting position of the conductive sealing ring 23.

By provision of the conductive sealing ring 23 in a space surrounded by the first terminal 21, the fixing member 22 and the cap plate 10 and after the first terminal member 20 being mounted to the cap plate 10, the conductive sealing ring 23 is always tightly pressed and fills the entire space so that respective sides of the conductive sealing ring 23 is subject to a uniform pressure, that is to say, the cap plate 10, the first terminal 21 and the fixing member 22 can provide a stable compressive stress to the conductive sealing ring 23, and thereby a stable contact area is formed between the conductive sealing ring 23 and the cover sheet 11 as well as the first terminal 21. The conductive sealing ring 23 can provide a stable resistance value between the cover sheet 11 and the first terminal 21. Therefore, it is possible to prevent warpage or deformation of the conductive sealing ring 23 caused by an unstable pressure on its mating surfaces with the cover sheet 11 and the first terminal 21 and in turn separation from the first terminal 21 and/or the cover sheet 11, and thereby prevent changes in the resistance value provided by the conductive sealing ring 23.

In the case that the first terminal 21 is a positive terminal, by providing the conductive sealing ring 23 to provide a stable resistance value between the cover sheet 11 and the first terminal 21, it is able to prevent increase in potential difference between the positive terminal and the cover sheet 11 (i.e., the potential of the cover sheet 11 and the shell become decreased) caused by the resistance value between the cover sheet 11 and the first terminal 21 upon electrical connection thereof deviating from a preset value (generally, the actual resistance value is higher than the set value), and prevent the potential of the cover sheet 11 from decreasing to below a critical potential value (where the shell is corroded) and thus prevent the problem that the cover sheet 11 and the shell are corroded by electrolyte.

Since the conductive sealing ring 23 fills the entire space, it is able to prevent metal burrs formed when the cover sheet 11 punches the first electrode lead-out hole from overlapping with the first terminal 21 and the cover plate 11 to avoid a direct connection of the first terminal 21 with the cover sheet 11 causes the resistance of the conductive sealing ring 23 to lose its function, and thus prevent sparking during the nail penetration test. In addition, since the conductive sealing ring 23 is compressed between the cover sheet 11 and the first terminal 21 and its contact area with the cover sheet 11 and the first terminal 21 is stable, an effective value of the resistance provided by the conductive sealing ring 23 between the first terminal 21 and the cover sheet can be increased. That is, the conductive sealing ring 23 can provide a same resistance value between the cover sheet 11 and the first terminal with a smaller volume than a former conductive member. Thus, the volume of the conductive member can be reduced, that is, the cross-sectional area of the conductive sealing ring 23 can be reduced. Therefore, not only the space occupied by the conductive sealing ring 23 can be reduced, but also production cost of the cap assembly 101 can be reduced.

In this way, the cap assembly 101 of embodiments of the present disclosure is able to provide, by using the conductive sealing ring 23, a stable resistance value between the first terminal 21 and the cover sheet 11 while achieving sealing and electronic connection of the first terminal 21 and the cover sheet 11. In the case that the first terminal 21 is a positive terminal, it is able to make the shell is positively charged to avoid corrosion of the shell of the secondary battery, and thus safety and reliability of the nail penetration test can be improved. Further, by providing the conductive sealing ring 23 with a certain resistance value, the structure of the cap assembly 101 can be simplified and unnecessary redundant components can be avoided such that the cap assembly 101 has advantages of simple installation, excellent sealing performance and the like.

In an optional embodiment, the space surrounded by the cap plate 10, the first terminal 21 and the fixing member 22 is at least partially enclosed. Preferably, the space may be completely enclosed. The term “enclosed” herein does not mean “sealed”, but indicates that the conductive sealing ring 23 can be isolated from outside of the space to some extent because the space is enclosed. In this way, influence of water vapor inside or outside the shell on the conductive sealing ring 23 can be at least partially reduced, so as to prevent mating surfaces of the conductive sealing ring 23 with the cover sheet 11 and the first terminal 21 from being subject to an unstable pressure due to it being exposed to the water vapor and thus prevent the conductive sealing ring 23 from providing an unstable resistance value.

In an optional embodiment, the conductive sealing ring 23 may be made of an elastic material, so as to improve compressive performance of the conductive sealing ring 23. In this way, the seal between the cover sheet 11 and the first terminal 21 can be improved, and a more uniform and stable pressure can be provided by the cap plate 10, the first terminal 21 and the fixing member 22 to the conductive sealing ring 23 such that the conductive sealing ring 23 is always subjected to a uniform and stable compressive stress and thereby the contact area of the conductive sealing ring 23 with the cover sheet 11 and the first terminal 21 is more stable. Therefore, even under influence of thermal expansion and contraction, the mating surfaces of the conductive sealing ring 23 and the cover sheet 11 as well as the first terminal 21 are not separated, so that a stable resistance value can be provided by the conductive sealing ring 23 between the cover sheet 11 and the first terminal 21.

In an optional embodiment, the elastic material may be rubber. For example, it may include one or more of the following materials: conductive fluororubber, conductive EPDM rubber and conductive nitrile rubber. It may be made of a master batch of fluororubber, EPDM or nitrile rubber with a conductive material added therein. The conductive material may include, for example, conductive carbon fiber, conductive carbon powder, conductive ceramic, and metal powder.

In an optional embodiment, if the resistance value of the conductive sealing ring 23 ranges from 1 ohm to 10⁵ ohm, its compression ratio ranges from 15% to 50%. The compression ratio indicates a ratio of thickness of the conductive sealing ring 23 before and after it is compressed in the compression direction. Since a resistance value of a resistor is related to material, length and cross-sectional area of the resistor, length and cross-sectional area of the resistance between the cover sheet 11 and the first terminal 21 can be changed by changing the amount of compression of the conductive sealing ring 23. Therefore, after the conductive sealing ring 23 is placed around the periphery of the first terminal 21, the resistance value of the conductive sealing ring 23 can be changed by adjusting the amount of compression of the conductive sealing ring 23. For example, radial size or thickness of the conductive sealing ring 23 can be increased or decreased. However, once the entire first terminal member 20 is assembled to the cap plate 10, the conductive sealing ring 23 fills the entire space and is in a stable state under the pressing force provided by the cap plate 10, the first terminal 21 and the fixing member 22. That is, the conductive sealing ring 23 is not separated from the cover sheet 11 and the first terminal 21 so as to ensure stability of the resistance value between the cover sheet 11 and the first terminal 21. Therefore, the amount of compression of the conductive sealing ring 23 can be adjusted according to actual needs so as to adjust the resistance value of the conductive sealing ring 23.

In an embodiment, for example, the second terminal member 30 (i.e., the negative terminal member) includes a second terminal 31, a fixing member 32 and an insulating sealing ring 33. The second terminal 31 is a negative terminal and includes a terminal body and an electrical connection plate 311 connected with the terminal body. In the embodiment, the terminal body and the electrical connection plate 311 of the negative terminal 31 are separate structures. The second terminal 31 may be made of a copper-aluminum composite material (that is, the terminal body is made of aluminum or aluminum alloy while the electrical connection plate 311 is made of copper or copper alloy material) so as to prevent the copper material of the second terminal 31 being exposed to the air and oxidized. In the second terminal member 30, the insulating sealing ring 33 is used to achieve seal and an electrical insulation of the second terminal 31 at the second electrode lead-out hole. The general structure of the second terminal member 30 and its installation on the cap plate 10 are similar to that of the first terminal member 20 and is not described redundantly.

In the above description of the embodiments, it is discussed with an example using the first terminal 21 as a positive terminal connected to a positive plate of the electrode assembly within the shell and the second terminal 31 as a negative terminal connected to a negative plate of the electrode assembly. However, the embodiments of the present disclosure are not limited thereto. In other embodiments, the first terminal 21 may be a negative terminal, and the second terminal 31 may be a positive terminal. When the first terminal 21 is a negative terminal, the shell is made of a metal material with a relatively high potential and the positive terminal is electrically insulated from the cover sheet 11 of the cap plate 10. Therefore, through the conductive sealing ring 23, it is still possible to electrically connect the first terminal with the cover sheet 11 and keep the resistance of the conductive sealing ring 23 stable.

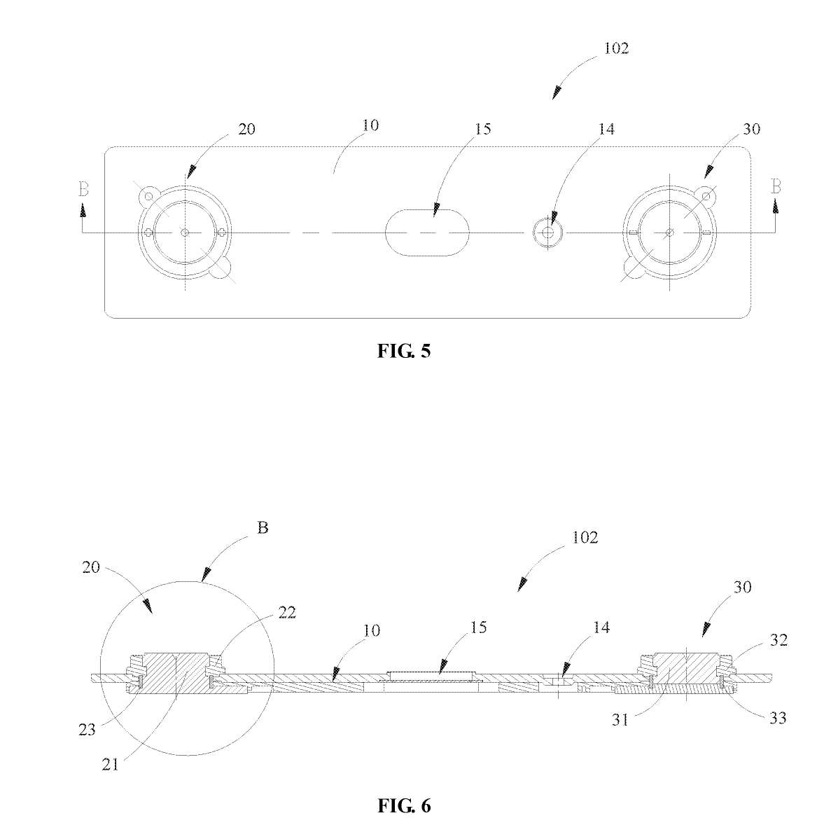

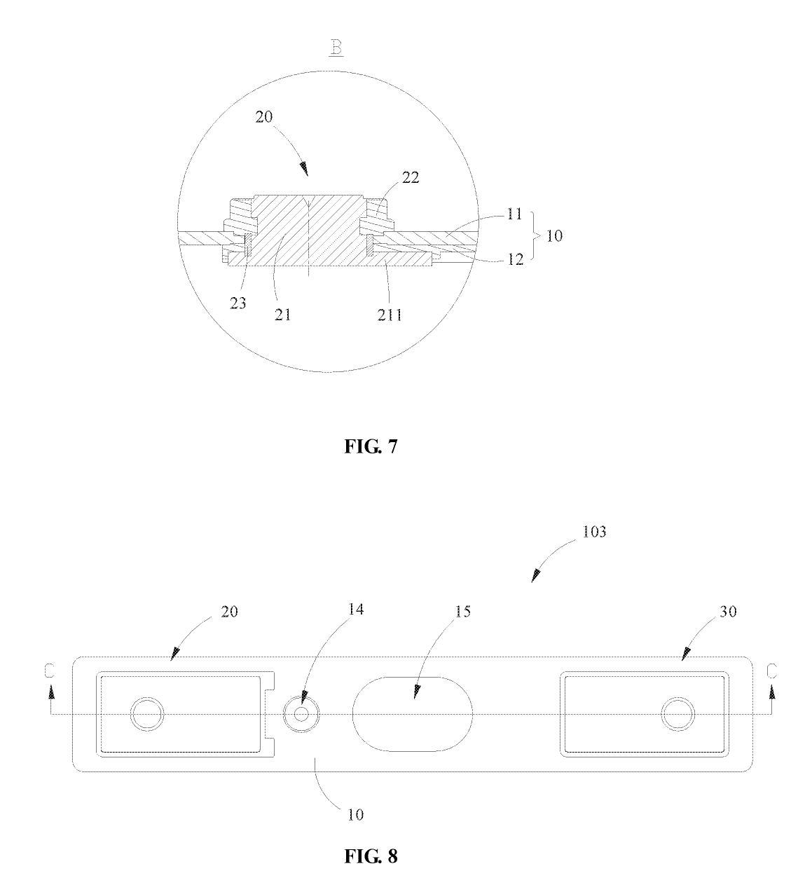

FIG. 5 is a schematic top view of a structure of a cap assembly 102 of a secondary battery (hereinafter referred to cap assembly 102) according to a second embodiment of the present disclosure. FIG. 6 is a schematic cross-sectional diagram of the structure of the cap assembly 102 of FIG. 5 taken along the B-B direction, and FIG. 7 is an enlarged partial view of a portion B of the cap assembly 102 of FIG. 6. As shown in FIG. 5, FIG. 6 and FIG. 7, the structure of the cover assembly 102 in the present embodiment is similar to that of the cover assembly 101 in the above embodiment. In the present embodiment, the same components as those in the above embodiment are denoted by the same reference numerals and the same components as in the above embodiment will not be described in detail.

In the present embodiment, the cover assembly 102 also includes a cover plate 10 and a first terminal member 20 and a second terminal member 30 provided on the cover plate 10. A difference from the cap assembly 101 of the above embodiment is that the conductive sealing ring 23 in the first terminal member 20 and the insulating sealing ring 33 in the second terminal member 30 of the cap assembly 102 in the present embodiment are compressed in a different manner. In the following, the first terminal member 20 is taken as an example to describe installation of the conductive sealing ring 23 on the cap plate 10.

The first terminal member 20 includes a first terminal 21, a fixing member 22 and a conductive sealing ring 23. In an optional embodiment, as shown in FIG. 7, the fixing member 22 fixes the first terminal 21 in the cap plate 10. In the embodiment, the space is also formed by the cover sheet 11, the first insulating plate 12, the first terminal 21 and the fixing member 22. However, in the embodiment, the conductive sealing ring 23 is pressed against a bottom surface of the fixing member 22, through-hole walls of the cover sheet 11, through-hole walls of the first insulating plate 12, an outer surface of the electronic connection plate 211 and the terminal body of the first terminal 21 in a surface contact manner. That is, the cover sheet 11 and the first terminal 21 press the conductive sealing ring 23 in a radial direction of the conductive sealing ring 23 respectively from an inner surface and an outer surface of an annular structure of the conductive sealing ring 23. Therefore, it is possible to make the conductive sealing ring 23 always receive a uniform compressive stress. The insulating sealing ring 33 of the second terminal member 30 is provided in the same manner as the conductive sealing ring 23 of the second terminal member 30, and will not be described in detail. In addition, the cap assembly 102 in the present embodiment can attain the same beneficial effects as those of the cap assembly 101 in the above embodiment, and therefore will not be further described.

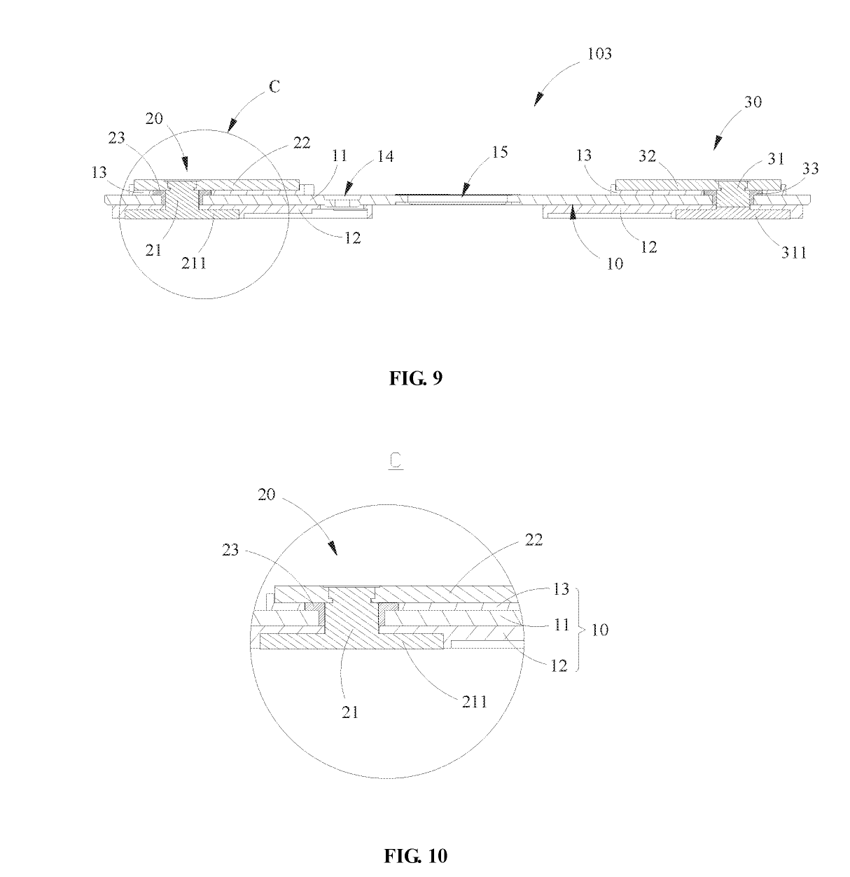

FIG. 8 is a schematic top view of a cap assembly 103 of a secondary battery (hereinafter simply referred to as a cap assembly 103) according to a third embodiment of the present disclosure. FIG. 9 is a cross-sectional diagram of the structure of the cap assembly 103 of FIG. 8 taken along the C-C direction, and FIG. 9 is a cross-sectional diagram of the structure of the cap assembly 103 of FIG. 8 taken along the C-C direction. As shown in FIG. 8, FIG. 9 and FIG. 10, the structure of the cover assembly 103 in the present embodiment is similar to that of the cover assembly 101 in the above embodiment. In the present embodiment, the same components as those in the above embodiment are denoted by the same reference numerals and the same components as in the above embodiment will not be described in detail

The cover assembly 103 in the present embodiment also includes a cap plate 10, a first terminal member 20 and a second terminal member 30 disposed on the cap plate 10. Differences from the cap assembly 101 of the above embodiment include that structure of the first terminal member 20 in the cap assembly 103 and installation manner therefor on the cap plate 10 as well provision of the conductive sealing ring 23 are different from the above embodiment, and structure of the second terminal member 20 and installation manner therefor on the cap plate 10 as well provision of the conductive sealing ring 33 are also different from the above embodiment. In the following, the first terminal member 20 is taken as an example to describe the cap assembly 103.

In an optional embodiment, as shown in FIG. 10, the cap plate 10 includes a cover sheet 11, a first insulating plate 12 and a second insulating plate 13. The first insulating plate 12 and the second insulating plate 13 are attached closely to an inner surface and an outer surface of the cover sheet 11 respectively. Each of the first insulating plate 12 and the second insulating plate 13 has a through hole thereon at a position corresponding to the first terminal 21 and the second terminal 31 for pass of the first terminal 21 and the second terminal 31. Preferably, the first insulating plate 12 and the second insulating plate 13 are divided into two parts corresponding to the first terminal member 20 and the second terminal member 30.

The first terminal member 20 includes a first terminal 21, a fixing member 22 and a conductive sealing ring 23. In this embodiment, the first terminal 21 also includes a terminal body and an electrical connection plate 211 integrally connected to the terminal body. Since the first terminal 21 in this embodiment has a relatively small diameter, the fixing member 22 is provided to electrically connect the first terminal 21. That is, the first terminal 21 can be electrically connected to an outer member through the fixing member 22. The fixing member 22 is a conductive block made of a metal material. For example, the fixing member 22 can be made of the same material as the first terminal 21 (i.e., aluminum or aluminum alloy).The fixing member 22 is also located on a side of the cover sheet 11 away from the shell and engaged with the first terminal 21 (such as by locking, which may also be referred to as “riveting”) to fix the first terminal 21 to the cap panel 10. The second insulating plates 13 is interposed between the fixing member 22 and the cover sheet 11. The first insulating plate 12 is interposed between the electronic connection plate 211 and the cover sheet 11.

In this embodiment, the space is surrounded by the fixing member 22, the second insulating plate 13, the cover sheet 11, the first insulating plate 12 and the first terminal. However, in this embodiment, the conductive sealing ring 23 is pressed tightly by an inner surface of the fixing member 22, through-hole walls of the second insulating board 13, through-hole walls of the cover sheet 11, an outer surface of the first insulating board 12 and the terminal body of the first terminal 21.That is, the conductive sealing ring 23 is pressed tightly by the cover sheet 11 and the first terminal 21 in a height direction and a radial direction of the conductive sealing ring 23. Therefore, it is possible to make the conductive sealing ring 23 always receive a uniform compressive stress. The structure of the second terminal member 30 and compression of the insulating sealing ring 33 are the same as the structure of the first terminal member 20 and compression of the conductive sealing ring 23, respectively, and will not be described in detail. In addition, the cap assembly 103 in this embodiment has the same beneficial effects as those of the cap assembly 101 in the above embodiment, and thus will not be further described.

In the above embodiment, the first terminal member 20 and the second terminal member 30 are mounted on the cap plate 10 in the same manner, but the embodiments of the present disclosure is not limited thereto. In other embodiments, the first terminal member 20 and the second terminal member 30 may be mounted on the cap panel 10 in respective different mounting manners. For example, in an embodiment, the first terminal member 20 may be mounted on the cap panel 10 by the mounting method in the first embodiment, and the second terminal member 30 may be mounted on the cap panel 10 by the mounting method in the second embodiment.

According to an embodiment of the present disclosure, there is also provided a secondary battery (not shown in the drawing). The secondary battery includes: a shell having an opening; an electrode assembly provided within the shell through the opening, and a cap assembly of the secondary battery according to any of the above embodiments. The electrode assembly includes a first electrode and a second electrode having an opposite polarity to the first electrode. The first electrode of the electrode assembly is electrically connected to the first terminal of the cap assembly of the secondary battery so as to achieve an electrical connection with outside. The secondary battery has the same advantages as the cap assembly of the secondary battery described above, which will not be redundantly described.

In summary, the cap assembly for a secondary battery and the secondary battery according to embodiments of the present disclosure are configured by providing a conductive sealing ring 23 having a predetermined resistance value between the cover sheet 11 of the cap plate 10 and the first terminal 21 of the first terminal member 20 and making the conductive sealing ring 23 be in a tightly pressed state so as to provide, through the conductive sealing ring 23, a stable resistance value between the cover sheet 11 and the first terminal 21 while achieving an electrical connection between the cover sheet 11 and the first terminal 21 and seal between the first terminal 21 and the first electrode lead-out hole. The ohmic connection between the cover sheet 11 and the first terminal 21 through the conductive sealing ring 23 can also simplify the structure of the cap assembly of the secondary battery so as to reduce manufacturing cost and save man-hour for assembly.

The conductive sealing ring 23 may be made of an elastic material to enhance its own compression performance so that the conductive sealing ring 23 is always subjected to a uniform and stable compressive stress and thereby a stable contact area can be provided between the conductive sealing ring 23 with the cover sheet 11 and the first terminal 21. Further, the conductive sealing ring 23 fully fills the space for its accommodation, which also contribute to a stable contact area between the conductive sealing ring 23 and the cover sheet 11 and the first terminal 21, so as to prevent the conductive sealing ring 23 from deforming or even being separated from the cover sheet 11 and/or the first terminal 21 due to an unstable force provided at the joint surfaces between the conductive sealing ring 23 and the cover sheet 11 as well as the first terminal 21, and in turn prevent changes in the resistance value of the conductive sealing ring 23.

Further, by controlling the compression ratio of the conductive sealing ring 23, the resistance value provided by the conductive sealing ring 23 can be adaptively adjusted according to actual needs, so as to increase flexibility of the cap assembly of the secondary battery.

The invention may be embodied in other specific forms without departing from the spirit and essential characteristics thereof. The embodiments discussed therefore should be considered in all aspects as illustrative and not restrictive. The scope of the invention is defined by the appended claims rather than by the foregoing description, and those modifications falling within the meaning and equivalents of the claims are thus intended to be embraced by the scope of the invention. Different technical features in different embodiments may be combined to obtain beneficial effects. Other variations of the described embodiments can be understood and practiced by those skilled in the art upon studying the drawings, the specification and the claims herein.

What is claimed is:

1. A cap assembly or a secondary battery, comprising:
a cap plate including a cover sheet having a first electrode lead-out hole; and
a first terminal member including a first terminal and a conductive sealing ring;
wherein the first terminal penetrates into the first electrode lead-out hole, the conductive sealing ring surrounds the first terminal and seals the first electrode lead-out hole, the conductive sealing ring is in a compression state, the first terminal is electrically connected with the cover sheet through the conductive sealing ring, and the conductive sealing ring has a resistance value greater than a resistance value of the first terminal.

2. The cap assembly for a secondary battery according to claim 1, further comprising a fixing member located on one side of the cap plate and engaged with the first terminal in order to fix the first terminal to the cap plate, wherein the conductive sealing ring is disposed in a space surrounded by the first terminal, the cap plate and the fixing member.

3. The cap assembly for a secondary battery according to claim 2, wherein the conductive sealing ring is in surface contact with the cap plate, the first terminal and the fixing member respectively.

4. The cap assembly for a secondary battery according to claim 3, wherein the space is enclosed and the conductive sealing ring fills the space.

5. The cap assembly for a secondary battery according to claim 1, wherein the conductive sealing ring is made of an elastic material.

6. The cap assembly for a secondary battery according to claim 2, wherein the conductive sealing ring is made of an elastic material.

7. The cap assembly for a secondary battery according to claim 3, wherein the conductive sealing ring is made of an elastic material.

8. The cap assembly for a secondary battery according to claim 4, wherein the conductive sealing ring is made of an elastic material.

9. The cap assembly for a secondary battery according to claim 5, wherein the resistance value of the conductive sealing ring ranges from 1 ohm to 10⁵ ohm.

10. The cap assembly for a secondary battery according to claim 9, wherein the conductive sealing ring has a compression rate from 15% to 50%.

11. The cap assembly for a secondary battery according to claim 9, wherein the elastic material is one of conductive fluororubber, conductive ethylene-propylene-diene monomer and conductive nitrile rubber.

12. The cap assembly for a secondary battery according to claim 1, wherein the first terminal is a positive terminal.

13. A secondary battery, comprising:
a shell having an opening;
a electrode assembly provided within the shell and including a first electrode and a second electrode, wherein the second electrode has an opposite polarity to the first electrode; and
a cap assembly of the secondary battery according to claim 1, wherein the cap assembly covers the opening of the shell, and the first electrode of the electrode assembly is connected electrically to the first terminal.
